(19) United States
(12) Patent Application Publication
(10) Pub. No.: US 2005/0173205 A1
(43) Pub. Date: Aug. 11, 2005

(54) Disc brake equipped with a floating caliper and several outer brake pads directly supported on the brake anchor plate

(76) Inventors: Uwe Bach, Niedernhausen (DE); Uwe Hendrich, Steinbach (DE); Rolf Weiler, Eppstein (DE); Hans Bungert, Geisenheim (DE); Stefan Heinz, Eppstein (DE)

Correspondence Address: RATNERPRESTIA, P O BOX 980, VALLEY FORGE, PA, 19482-0980, US

(21) Appl. No.: 10/514,223

(22) PCT Filed: May 12, 2003
(86) PCT No.: PCT/EP03/04935

(30) Foreign Application Priority Data
May 14, 2002 (DE) 102 21 516.2

(51) Int. Cl. F16D 55/228

(52) U.S. Cl. 188/72.5; 188/73.39

(57) ABSTRACT

Floating-caliper brake including a brake support member, a floating caliper straddling the outside edge of a brake disc and being axially displaceably guided on the brake support member, brake pads arranged on either side of the brake disc and enclosed by floating caliper, with at least two of the brake pads being arranged on the axially inside surface of the brake disc and at least two of the brake pads being arranged on the axially outside surface, the inward brake pads being displaceable on the brake support member. An object of the invention in a floating-caliper disc brake of this type is to achieve a design with reduced weight and, additionally, enhance the assembly and improve the function of the brake. This object is achieved in that the two outside brake pads are supported by arms of the brake support member that straddle the brake disc, and in that the floating caliper makes catch at the two outside brake pads simultaneously. The sub claims disclose favorable improvements of the invention.

### TECHNICAL FIELD

The present invention relates to a disc brake, in particular for motor vehicles equipped with a floating caliper, which is displaceably supported on a brake support member that can be mounted on the vehicle.

### BACKGROUND OF THE INVENTION

Motor vehicles designed for high driving speeds require brakes with an increased efficiency. To reach a higher braking capacity, it is theoretically necessary to increase the friction surface of the brake pad. Thus, high-performance brakes necessitate, among others, a largest possible brake disc diameter. On the other hand, the diameters of the vehicle wheels shall not be enlarged. Because smaller wheels and, hence, also smaller brake discs are demanded in a modern vehicle concept, the ensuing consequence is to extend the brake pads in a tangential direction.

Previously known floating-caliper disc brakes, especially with frame-shaped floating calipers, wherein the tangential brake lining length relative to the radial brake lining height amounts to more than 1.5 times, due to these geometric conditions are in constructive ranges for the disc brake which are unfavorable when the brake lining is pressed against the associated brake disc. These conditions entail negative secondary phenomena especially in terms of brake comfort such as hot brake judder, cold brake judder, and tangential inclined wear of the brake pads. To take remedial measures in this respect it is known in the art to split up the otherwise too long brake pads into several brake pads arranged tangentially one behind the other.

EP 0 412 541 discloses a disc brake suitable for a high brake performance, the brake caliper of which is designed as a floating frame which is axially displaceable on a brake support member that is fixed to the steering knuckle of the vehicle and extends in an axial direction beyond the outside edge of the brake disc. The floating frame encloses four brake pads arranged on either side of the brake disc, and it transmits the application force. The brake pads on the outside of the brake remote from the piston are transmitted in the mentioned brake system onto the floating frame and propagate from there onto the brake support member. This indirect transmission of the force onto the brake support member causes transmission of the torques exerted on the floating frame to the brake pads, with the result that the brake becomes less stiff and augmented noise development and inclined wear of the brake pads must be expected. Thus, a construction of this type is less favorable for a very high bearing pressure distribution. The brake support member is connected to the vehicle at the axial inside of the wheel. In order to take up the circumferential forces of the two axially outside brake pads from the floating frame, the brake support member has one single brake support arm straddling the outside edge of the brake disc. The brake support arm extends through the middle of the space enclosed by the floating frame.

U.S. Pat. No. 6,357,559 discloses a construction similar to the one described hereinabove, wherein the forces taken up by the outside brake pads are also transmitted indirectly through the floating frame onto the brake support member.

DE-OS 4126196 also discloses a floating caliper equipped with respectively two brake pads on the piston side and on the side remote from the pistons. This construction does not arrange for an arm reaching over the brake support member. The stiff frame caliper is rather suspended close to the piston on the brake support member by means of a strong holding device.

DE-OS 10006464 discloses arranging several brakes with floating caliper jointly on a brake disc, similarly as described in DE-PS 19626901 in connection with fixed-type caliper brakes. In addition, DE-OS 10006464 discloses allocating a joint brake support member to the two floating calipers. This results in a comparatively complicated construction, which presumably has considerable weight still and demands a separate assembly of the two calipers.

### BRIEF SUMMARY OF THE INVENTION

Therefore, the invention is based on a disc brake including a brake support member, a floating caliper straddling the outside edge of a brake disc and being axially displaceably guided on the brake support member, brake pads arranged on either side of the brake disc and enclosed by floating caliper, with at least two of the brake pads being arranged on the axially inside surface of the brake disc and at least two of the brake pads being arranged on the axially outside surface, the inboard brake pads being displaceably guided on the brake support member. The object of the invention is to achieve a design with a reduced weight in a floating-caliper brake of this type and, additionally, to improve the assembly and enhance the function of the brake.

This object is achieved by an above described floating-caliper brake, wherein the two outside brake pads are supported by arms of the brake support member that straddle the brake disc, and in that the floating caliper makes catch at the two outside brake pads simultaneously. The invention principally involves introducing the brake forces directly into the brake support member in the floating caliper brake equipped with at least four brake pads on either side of the brake disc and arranging one joint caliper for all the brake pads. Said caliper is separated from the brake support member in terms of function in that the caliper generates the application forces in an axial direction for all brake pads, while the brake support member accommodates the tangential forces in a substantially direct manner.

A direct accommodation of the brake forces of this type can principally be achieved by means of four arms of the brake support member, as can be taken from DE-OS 10006464. To reach further simplification in the support member's shape as well as an increased strength, while additionally reducing its weight, a brake support member of the said disc brake comprises at least three, especially exactly three arms straddling the brake disc, extending in an axial direction and directly accommodating the forces exerted by the brake pads is advisable as an improvement of the invention. The two middle arms known in the art are united in one single arm in this arrangement.

The invention is per se appropriate also for brake pads subjected to tangential pressure forces (push). However, it is especially requested for long brake pads extending in a tangential direction that tensile forces are applied to them (also) in a tangential direction. To this end, as an improvement of the invention at least the leading-edge arm and the middle arm of the three arms of the support member are provided with grooves engaging into which are essentially radially extending, preferably radially inwards pointing lateral hooks of the brake pads. In this arrangement, the brake pads with their hooks are engaged into the grooves at the entry side with respect to the brake disc and transmit the tensile force exerted on them directly onto the leading arm of the support member or onto the middle arm of the support member with respect to the tangentially following brake pad. As is known, the individual components of the brake exposed to great stress are deformed in a braking operation so that the arms of the brake support member are slightly deflected elastically and the backing plates of the brake pads are slightly extended. In the brake of the invention, this fact can be utilized to the effect that the brake pads are initially are subjected to tensile load and then, with increasing load, move to bear on the exit side with respect to the brake disc against the associated brake support arms and, thus, are also subjected to compressive load. However, the distribution of the forces to two brake pads arranged one behind the other renders it also possible to have reduced maximum brake forces so that the brake pads only need to be subjected to tensile load at least in a forward direction of rotation of the brake disc. This results in improved comfort of the brakes, tending less to noise development.

In principle, it can further be favorable when the brake pads are capable of transmitting tensile forces in both directions of rotation of the brake disc. However, the following factors must be taken into consideration. To reach a tensile load on the brake pads, it is necessary that the brake pads include hooks on their leading edges that are engaged into corresponding undercuts on the brake support member and/or on the brake caliper. Hooks of this type permit extending the brake pads and, thus, the brake itself. This extension is frequently in contrast to the mounting space available for the brake. The said floating caliper brake wherein the arms and the brake pads are so configured that in the forward direction of rotation of the brake disc the brake pads are only subjected to tensile load in circumferential direction and only to compressive stress in the backward direction of rotation provides a remedy in that the brake pads are subjected to tensile load in the mainly effective forward direction of rotation of the brake disc, while the brake pads are subjected to compressive stress in the backward direction of rotation of the brake pads that is very rarely effective. This maintains the advantage achieved by the tensile load during the dynamic braking operation, while the compressive stress of the brake pads occurring during the usually static braking in the backward direction of rotation of the brake disc (e.g. traffic jam when driving uphill) does not cause any considerable disadvantages, but provides the advantage of a simpler design of the brake and a reduced mounting space.

To achieve the effect described above with simple means, it is advisable to provide exclusively the leading-edge arm and the middle arm of the three arms with each one groove, into which at least the two outward brake pads are engaged with an associated lateral hook in such a fashion that the brake pads are subjected to tensile load when the brake disc is rotated in the forward direction of rotation, and that preferably the sides of the brake pads lying opposite in circumferential direction have a design without hooks. In this arrangement, the brake pads are equipped with hooks only on the leading edge with respect to the forward direction of rotation of the brake disc, while only abutment surfaces for transmitting compressive forces in the backward direction of rotation of the brake disc are provided on the side of the brake pads that is opposite in a circumferential direction. It must be emphasized, however, that the brake system according to the invention may also be designed such that the brake pads are subjected to tensile stress with respect to both directions of rotation of the brake disc. The invention also allows using the per se known push-pull principle wherein the bending of the arm(s) on the leading edge is utilized such that the trailing-end arm takes over part of the load when higher brake forces prevail. The invention also permits combinations wherein, for example, different principles are used on either side of the brake disc, such as a mere tensile load of the brake pads close to the piston and a push-pull load of the brake pads on the outward side of the brake disc remote from the piston.

It is an objective in a preferred aspect of the invention to have the brake pads engage the brake support member in such a fashion that they are not lifted in a radial direction during the braking operation. Such a lifting movement must be feared because the center axles of the individual brake pads are no longer positioned symmetrically with respect to the center axle of the caliper in the invention at issue. Thus, radial forces that differ from each other are applied to the ends of the respective brake pads and can cause a torque at the brake pads, with the possible result of lifting forces. To reach a further improvement of the invention in this respect, the brake pads arranged in one plane are positioned at an angle relative to each other, and the abutment surfaces of the brake pads and of the arms corresponding to each other are likewise arranged at an angle in order to transmit forces. These features permit achieving that the center axle of the brake pads is aligned to the radial axis of the brake disc so that the brake pads can be aligned exactly in the circumferential direction of the brake disc. This allows eliminating the radial forces at the brake pads. The respective angle depends on the distance of the center axles of the two brake shows, with said angle growing with a rising distance of the center axles. Radial forces of this type are also avoided when the direction of rotation of the brake disc has changed.

The angular positioning of the brake pads lying tangentially one behind the other is very advantageous because radial forces lifting the brake pads are virtually avoided. As the abutment surfaces between brake pad and support member or floating caliper extend radially in each case and, thus, at an angle with respect to the two brake pads lying one behind the other, it is only possible to mount or remove the brake pads in principle only in the respective radial direction. This means that the brake pads would have to be inserted in different angles into the brake support member, or removed therefrom. Such a type of mounting or dismounting the brake pads is complicated and costly. Therefore, attempts are made to render possible a common assembly of the brake pads in the brake of the invention, even when the brake pads are arranged at an angle relative to each other. It is advisable as an improvement of the invention, to secure both the brake pads on the piston side and the brake pads on the opposite outside surface of the said floating caliper brake in the floating caliper so as to be displaceable at least laterally. The movable attachment of the brake pads at the floating caliper makes it possible to simultaneously mount all brake pads with regard to their associated abutment surfaces or grooves by means of a radial movement of the caliper, with the brake pads moving in a circumferential direction simultaneously with the radial movement of the caliper. As this occurs, the brake pads may be suspended at an angle relative to each other in the caliper already prior to the assembly. This principle naturally applies not only to mounting but also dismounting, so that all brake pads can be removed jointly from the brake support member. Further, this principle is applicable when all brake shoes are furnished with hooks on both sides and, thus, can be subjected to tensile load exclusively, or when the brake pads are subjected to tensile load only in the forward direction of rotation according to the combination of features as claimed in claims 4 and 5. It is, therefore, a particularly important aspect of the invention that the brake pads arranged in one plane are positioned at angles relative to each other, on the one hand, but all (e.g. four) brake pads can be mounted or dismounted jointly with the caliper due to its radial movement, on the other hand.

In practical operations, this can be done because guiding slopes are provided at the hooks of the brake pads and/or the walls of the grooves or other surfaces used for support by means of which guiding slopes the brake pads are mounted into the grooves by way of a tangential movement during a radial movement of the floating caliper. The tangential direction of movement of the brake pads is chosen such that the hooks, after the installation, will abut on the associated groove wall allowing tensile forces of the respective brake pad to be directly transmitted to the groove wall.

Where the objective is to subject at least one brake pad on each side of the brake disc to tensile load even during the backward direction of rotation, it is favorable to include in the middle one of the three arms two grooves extending in parallel in axial direction relative to each other. Said grooves being engaged by lateral hooks of the adjoining brake pads. It is additionally favorable in this respect that the brake pad concerned can be configured symmetrically in this case so that it can be easily exchanged with other brake pads during mounting. The combination of features can be applied advantageously especially when all brake pads are subjected to tensile stress in both directions of rotation and, accordingly, are equipped with hooks on both sides since then all brake pads can have the same symmetrical design and are exchangeable. Also in the case that all brake pads are provided on both sides with one hook respectively, it is possible to transmit only tensile forces in one direction and only compressive forces in the opposite direction onto the groove walls by setting the position of the hooks and the position and the width of the grooves correspondingly.

In order to still better distribute the forces exerted by the brake disc on the brake, it is advisable as an improvement of the invention that the brake pads include additional radially outwards pointing hooks that make catch at associated edges of the floating caliper and, in doing so, transmit tensile forces exerted on the brake pads onto the floating caliper. In this arrangement, the radially outwards pointing hooks make catch in a pulling manner on the lateral surface of the bridge of the caliper in a circumferential direction, with the result that the caliper takes up brake forces and transmits them to the brake support member in an appropriate fashion. For the case that the brake pads are only subjected to tensile load in the forward direction of rotation, it is advisable to transmit the forces that act on the caliper to the otherwise unloaded trailing arm. It can be additionally advisable in this construction to guide the caliper in an axial direction at shoulders on the brake pads, at the ends of which the mentioned hooks are disposed. It is, however, also possible to omit the last mentioned combination of features and to use the radially upwards projecting hooks only for the (tangential) lateral guide of the caliper in its axial movement. Thus, the caliper is guided tangentially in the area of the outward leg (on the fist side) by way of the brake pads retained by the arms indirectly in relation to the arms.

It is per se possible to pass through the middle arm of the brake support member below the housing of the caliper in an axial direction. However, it is advisable as an improvement of the invention in order to better utilize the mounting space which is narrow in the radial direction that the floating caliper in its mid-area has an opening into which the middle arm extends. Thus, the caliper which will frequently be referred to as housing in the following will not bend across the middle arm but succeed in a tangential direction on both sides of the middle arm. This provides additional possibilities in that upwards projecting hooks at the brake pads make catch at the lateral surface of the opening and the caliper can this way take up tensile forces of the brake pads in the area of the middle arm. An opening of this type additionally entails material economy and also ensures an additional discharge of heat by ventilation.

Usually, the caliper is guided on the piston side by way of guiding pins in relation to the brake support member. It is per se possible to configure a guide of this type in such a solid manner that the caliper does not require an additional guide on the side remote from the piston. As an improvement of the invention in order to save material and weight it is advisable that at least the outward brake pads include projections that point radially to the caliper and on which the caliper is guided in an axial direction. The lateral surface of the brake pads facing the caliper is additionally used for radially guiding the caliper during its axial movement. In order to maintain the caliper under all circumstances in engagement with the brake pads in a radial direction and to prevent impact noises between caliper and brake pads and brake pads and brake support member, a so-called housing spring is still provided which is supported from below on the brake support member and pulls the caliper against projections on the brake pads. The guiding surface between caliper and brake pads can be chosen to be very small in order to diminish friction. It is advisable to this effect as an improvement of the invention to provide the brake pad in the area of the projection with a recess to accommodate a sensor. A bag-shaped recess that is open to the outside is provided in the area of the projection of the brake pad so that the recess interrupts the surface of the caliper that abuts on the brake pad and the caliper is guided on two opposed projection parts.

In a preferred aspect of the invention to elastically suspend the outside brake pad on the caliper, the said floating caliper is provided with two cylinders, in that the floating caliper at its outside leg remote from the cylinders includes preferably circular holes, and the brake pads are elastically suspended on the walls of the pistons guided in the cylinder, or the holes, by way of springs secured to their carrier plates. Favorably, two pistons are provided which act on the associated brake pads on the piston side and thereby generate the necessary application force. To finish the cylinders of the pistons, corresponding holes are usually provided in the outside leg of the floating caliper. While it is per se known to elastically secure the piston-side brake pads in the pistons open towards the backing plates by way of springs on the backing plate, the invention discloses as an improvement to also use the lateral surfaces of these holes for anchoring the springs on the back side of the outboard brake pads. Advantageously, the holes have a circular design so that both the holes and the cylinders for the piston can be machined by way of an axial movement of a drill. When the drill is designed accordingly, the holes may also have the shape of an oblong hole if such a shape is favorable to fasten the outside (fist-side) brake pads. Said brake pads are clipped into the holes by way of the springs on the fist side.

The invention is suitable for different types of floating calipers. It can be implemented for a fist-type caliper and for a frame-type caliper. The present embodiment as a favorable improvement is based on that the caliper is formed of a combination of fist-type caliper and frame-type caliper, the fist-type caliper comprising a frame-shaped web that contributes to a higher degree of rigidity of the caliper. This is the meaning of the term ‘frame-shaped floating caliper’ used hereinbelow.

It has shown that in floating calipers, in particular fist-type calipers, the tangential inclined position of the caliper or the housing has an effect on the comfort behavior of the brake. This inclined position of the calipers is measured in series production with some manufacturers in order to detect fluctuations in production and intervene into the process when limit values are exceeded. In a one-cylinder caliper, the value for the inclined position lies within a small tolerance band. In the floating caliper according to the invention, this tolerance band increases considerably due to the larger number of cooperating components. Therefore, attempts have been made to avoid problems in comfort due to greatly varying tolerances in series production. An improvement of the invention discloses a floating caliper which is provided with adjusting means allowing the adjustment of the position of the caliper with respect to the position of at least one of the support member arms. The proposal involves providing mechanically active adjusting means that limit or preclude variations in the position between the support member arms or brake support member and the floating caliper.

To improve the precision of the adjustment, a favorable aspect recommends arranging adjusting means at the floating caliper in the area of the free end of at least one of the arms, in particular the exit-side arm, since in this area of the brake the displacement between caliper and support member arm becomes maximal and, thus, the desired position of the caliper or the housing can be adjusted most easily. It has already been explained hereinabove that the brake of the invention, at least in the forward direction of rotation, preferably subjects the brake pads to tensile load only and thereby enhances the comfort. However, this means that the trailing-end support member arm is not stressed in terms of a tangential force until the housing abuts on this support member arm due to an inclined position. More specifically: In the driving direction of forward travel which is especially important for the braking operation, the trailing-end support member arm stops, while the other two support member arms (subjecting the brake pads to tensile load) are deflected. Thus, when subjected to load, the housing will approach the trailing-end arm, which can enforce a predetermined distance between itself and the housing by means of the adjusting means used. When driving backwards, reverse conditions prevail accordingly so that the adjusting means are meant to act upon the support member arm then being at the trailing end (and at the leading edge during forward travel).

According to a preferred embodiment the floating caliper is a fist-type caliper, in that the outside arms extend until the level of the axial lateral surfaces at the bridge of the fist-type caliper, and in that at least one axial lateral surface includes adjusting means by means of which the position of the caliper can be fixed in relation to the arm in a circumferential direction. The adjusting means make catch at the lateral surface of the bridge of the caliper, provided the floating caliper is a fist-type caliper. The principle of the adjustment can be applied also to other caliper brakes, such as with a frame-type caliper.

The adjusting means themselves can be secured to the arms or to the bridge of the caliper. Favorably the adjusting means are secured to the caliper and configured as a shoulder adjustable in tangential direction and pointing in the direction of an abutment surface on the associated support member arm. Preferably, the adjusting means are attached to the caliper because the material is stronger at this point. The adjusting means may consist of an adjustable setscrew being adjusted in accordance with the measured condition of the caliper. Another possibility involves mounting a pin into a bore in the housing, if necessary, the length of the pin depending on the measured caliper position. For this purpose, pins of different lengths are available which are used in dependence on the measurement.

In this context it is especially effective to include the adjusting means in the two axial bridge surfaces opposite each other, in that the adjusting means are pluggable pins provided with a stop, and the pin end forming the shoulder and projecting from the caliper bridge is provided with markings, preferably circumferential grooves, and the number of the grooves depends on the height of the shoulder. The adjustment means being fitted on the two surfaces pointing outwards in a circumferential direction. The pluggable pins used as adjustment means are furnished with stops, by means of which their length in a circumferential direction is fixed in relation to the caliper. A stop of this type may e.g. consist of a step of a stepped circular cylinder. The first step that projects from the stop and points tangentially outwards can be differently long, and the respective length is indicated by appropriate markings on the pin.

The invention is not limited to the use of two brake pads on the piston side and on the outside surface. Thus, it is e.g. possible to use more than two brake pads on one side, if the number of arms of the brake support member is raised accordingly, with said number of arms being always by one larger than the number of the brake pads on one side. Also, it is not absolutely necessary that several brake pads are arranged on the piston side. It is covered by the invention to also arrange only one single brake pad. The same applies to the number of pistons used. It is substantial for the invention that the outside brake pads can support directly on the arms of the brake support member and that all brake pads are actuated by one single caliper.

### BRIEF DESCRIPTION OF THE DRAWINGS

FIG. 1a is a total perspective view from the outside of a first embodiment of a floating-caliper brake of the invention.

FIG. 1b is a view from the piston side of the floating-caliper brake according to FIG. 1a.

FIG. 1c is a view of the floating-caliper brake according to FIG. 1a, with the floating caliper removed.

FIG. 1d is a view of the floating-caliper brake according to FIG. 1b from a slightly different angle, with the floating caliper removed.

FIG. 2 is a view from outside on the side of the floating-caliper brake shown in FIG. 1a.

FIG. 3 is a view on the side of the floating-caliper brake shown in FIG. 1b.

FIG. 4 is a top view on the floating-caliper brake according to FIG. 1.

FIG. 5 is a view of FIG. 1c with a first position of the two outside brake pads.

FIG. 6 is a side view of FIG. 1c with a second position of the outside brake pads.

FIG. 7 is a cross-sectional representation of a view on the piston side with means for aligning the caliper relative to the brake support member.

FIG. 8 is a top view corresponding to FIG. 4 with the means according to FIG. 8.

FIG. 9 shows a modified pad holding spring.

FIGS. 10a to 10d show a second embodiment corresponding to the FIGS. 1a to 1d and modified with respect to this first embodiment.

FIG. 10e shows a housing holding spring with an integrated cover plate as shown in sections in FIG. 10a.

FIG. 11 is a partly sectional view on the side of the floating-caliper disc brake shown in FIG. 10a.

FIG. 12 is a view of FIG. 10c with a first position of the two outside brake pads.

FIG. 13 is a view of FIG. 10c with a second position of the outside brake pads.

FIG. 14 is a view of adjusting means for adjusting the inclined position of a caliper.

FIG. 15 is a broken-out sectional view of an adjusting means mounted into the caliper.

### DETAILED DESCRIPTION OF THE PREFERRED EMBODIMENTS

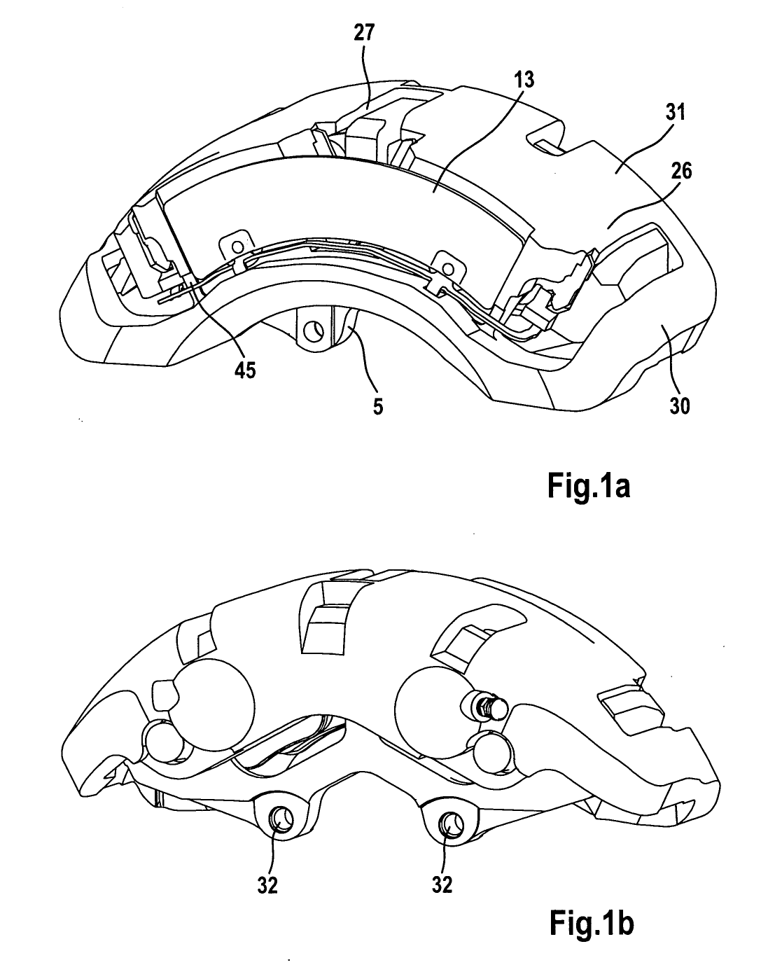

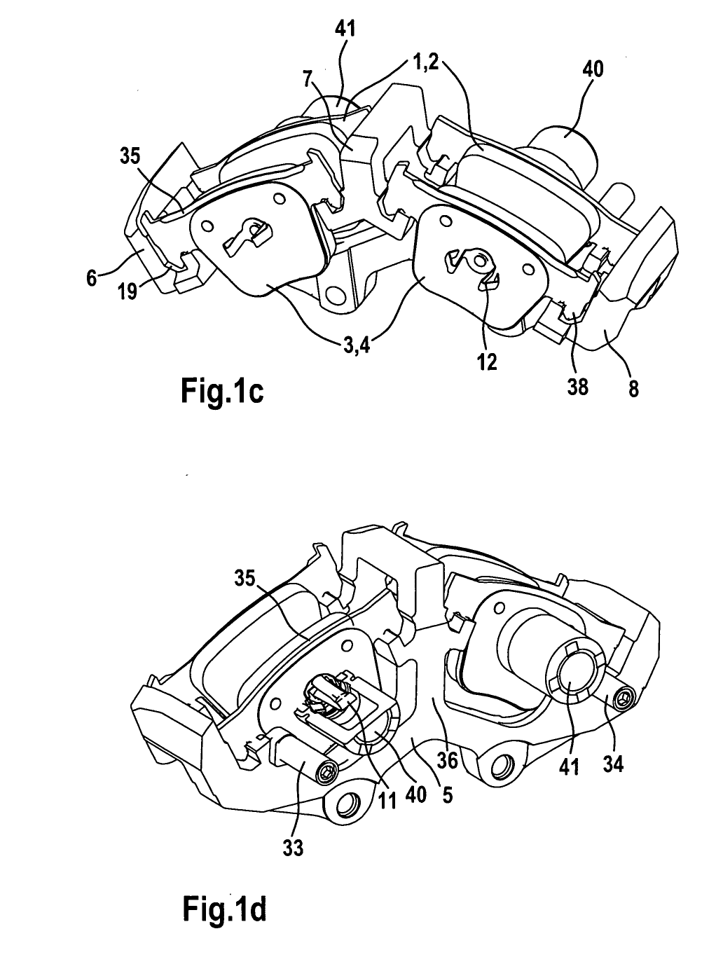

FIG. 1 shows a fist-type caliper 31 equipped with a frame 30 and being displaceable on a support member 5. The brake support member 5 can be fastened to the steering knuckle of a vehicle by means of mounting holes 32. Guiding pins 33, 34 on the support member 5 are used to guide the caliper 31 on the support member 5, and caliper 30 can additionally be supported on the backing plates 35 of the outboard brake pads 3, 4. The support member arms 6, 7 and 8 of support member 5 projecting from the mounting plate 36 in an axial direction are substantially U-shaped and straddle the brake disc (not shown). The arms 6, 7, 8 include grooves 18 (hereinbelow frequently referred to as broached profile) at their free ends of the respective legs, into which grooves radially downwards pointing hooks 38 of the brake pads 1 to 4 are engaged. This way, tensile forces exerted by the brake pads 1 to 4 and also compressive forces can be transmitted to the corresponding walls of grooves 19 (this so-called push/pull principle is per se known in the art, e.g. from DE 28 04 808 A1).

As can be seen in FIGS. 1c and 1d, the backing plates 35 of the brake pads 1 to 4 comprise springs 11, 12 by which they can be retained on the caliper 31. The ends of the legs of the inward springs 11 are supported from inside (as indicated in FIG. 1d) on the peripheral surface of the brake pistons 40, 41. The free ends of the legs of the outside springs 12 make catch at the edges of the holes 42, 43 that are used to machine the cylinders pertaining to the brake pistons 40, 41. The holes 42, 43 are assigned a double function this way. Thus, all brake pads 1 to 4 are elastically suspended in the caliper 31. The springs 11, 12 have two opposite legs in the present embodiment. Said springs may, however, also have three or more legs, as is shown in FIG. 9.

As becomes obvious from FIG. 1a and FIG. 1b, the caliper bridge 26 includes an opening 27 in its mid-portion in a circumferential direction, with the middle arm 7 of the brake support member 5 projecting into said opening.

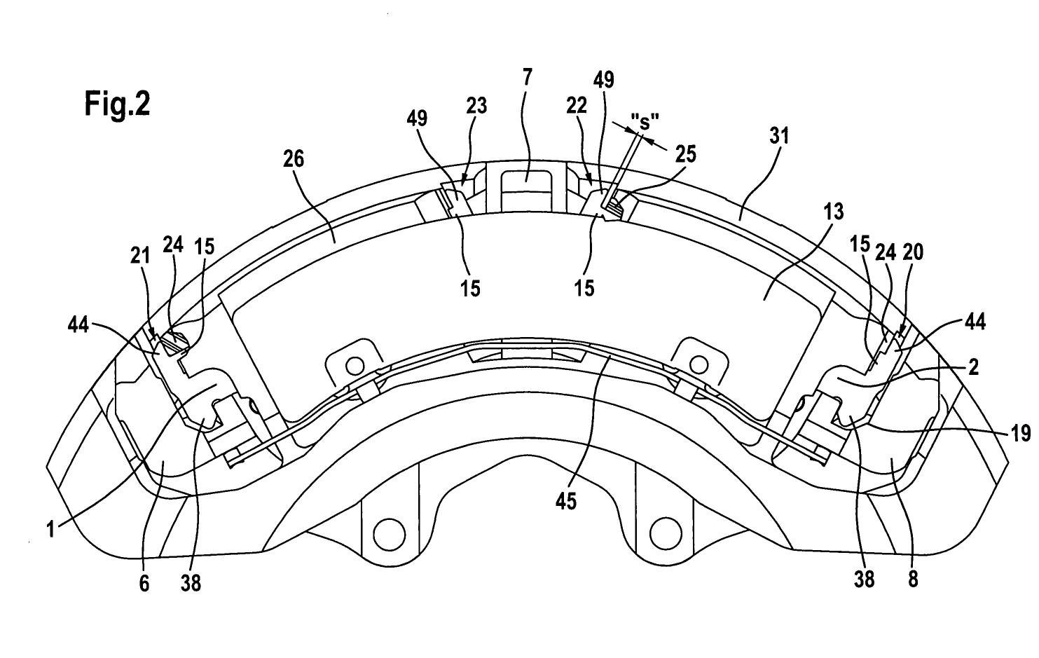

As is apparent from FIG. 2, the brake pads 1-4 not only have hooks 38, which point in a radial downward direction, but also hooks 44 pointing in the opposite direction. By means of these hooks they can make catch in a tangential direction at the tangential outside surfaces 20, 21 of the caliper that point in this direction and are thus subjected to tensile stress. Said hooks 44 can also be used only to guide the caliper in a tangential direction when it moves in an axial direction.

Further, a push/pull support of the brake pads on the brake support member can be reached. Broached profiles or grooves 19 are formed by a metal cutting operation on the brake support member or on the support member arms, into which the lateral projections (hooks) 38 of the brake pads 1-4 are engaged in a form-fit manner. Thus, the disc brake favorably includes in each case two serially arranged brake pads 1, 2 and 3, 4, respectively, per brake disc friction surface. The brake pads 1-4 are guided in an open brake support member 5 according to the push/pull principle, yet with three support member arms 6, 7, 8 projecting beyond the brake disc.

Further, it is apparent from FIG. 2 how the outside edges 24 of the caliper bridge 26 are radially supported on the lateral projections 15 of the outward brake pads 1 and 2. The same applies to the inside edges 25 of the caliper at the opening 27 of the caliper bridge 26 which are also supported on lateral projections 15 of the outward brake pads 1, 2. This arrangement allows guiding the caliper 31 in its area remote from the piston in an axial direction on the lateral projections 15 of the brake pads.

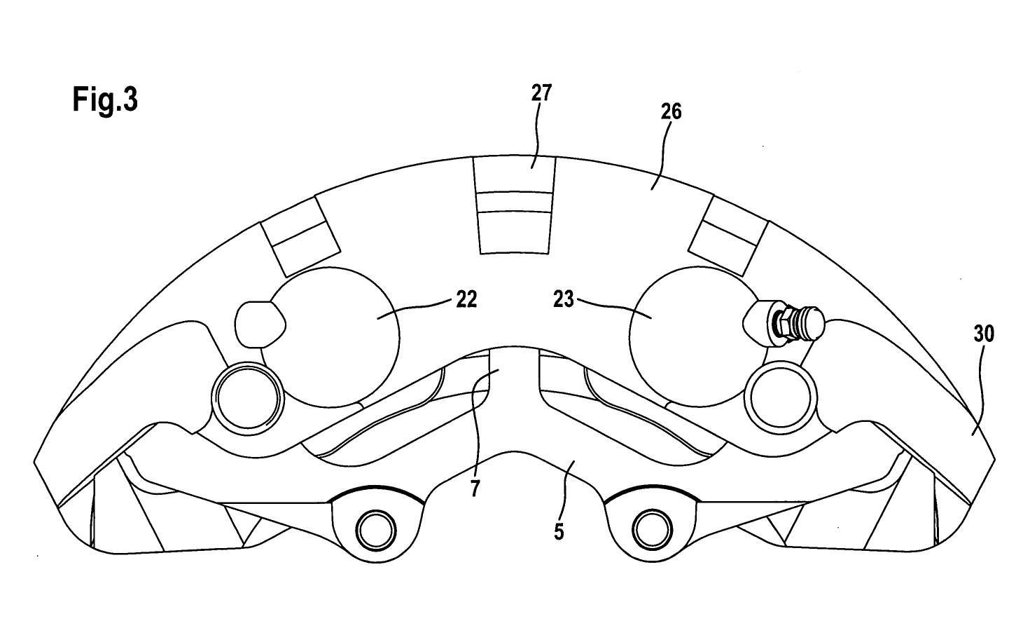

FIG. 3 shows the first embodiment of the brake of the invention in an enlarged view corresponding to the view of FIG. 1b (that means as viewed from the inside towards the piston side). The bulges 22, 23 on the inside leg of the caliper are disposed in front of the invisible cylinders in which the pistons 40, 41 are guided.

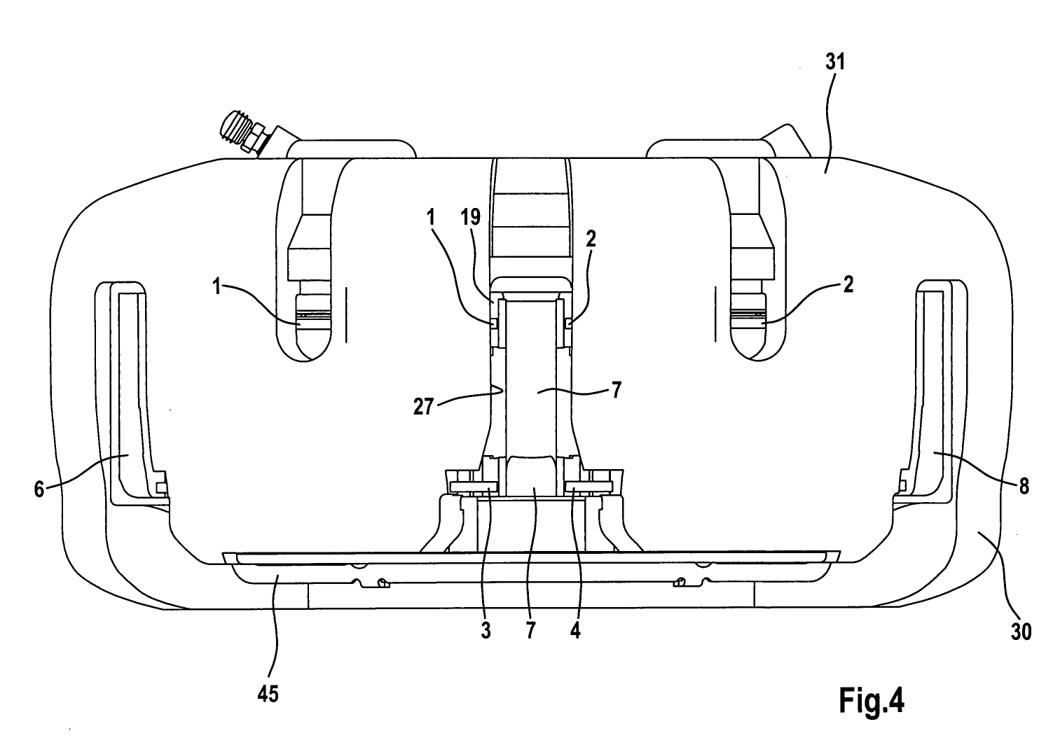

FIG. 4 shows a top view of the first embodiment of the brake of the invention with the position depicted in FIG. 1a.

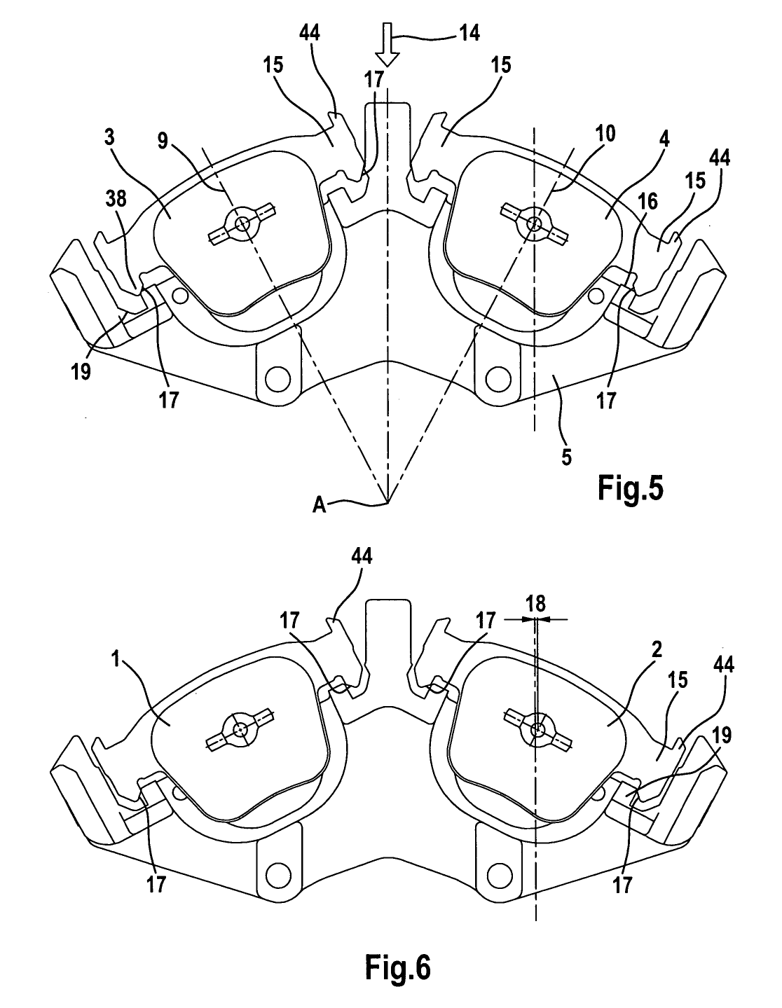

The brake pads 1-4, as illustrated in FIG. 5, are arranged with their center axles or axes of symmetry 9, 10 (see FIG. 5) in such a fashion that these axes always intersect the rotational axis A of the associated brake disc as if two independent brake calipers were mounted side by side. This prevents that the brake pads 1-4 are lifted out radially during brake application. Such an undesirable radial lifting of the brake pads 1-4 would have to be expected with broached profiles that are arranged tangentially in a straight line (that means not at an angle relative to each other) in the brake support member for the brake pad support due to the moment balances around the brake pad supporting points, which would be unfavorable then.

According to the invention, the broached profiles (grooves 19) for the slidable support of the brake pads 1-4 in a circumferential direction are arranged radially relative to the brake disc axis A. The thus individual broached profiles spread fanwise in a V-shaped configuration with respect to the brake disc axis A.

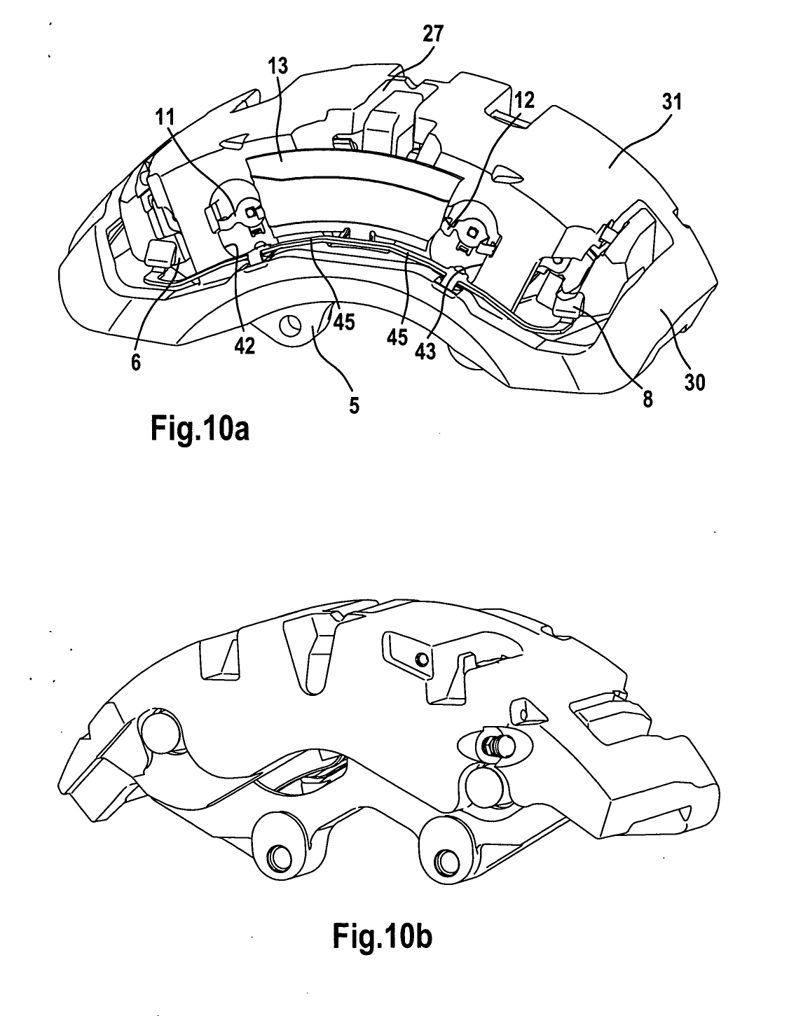

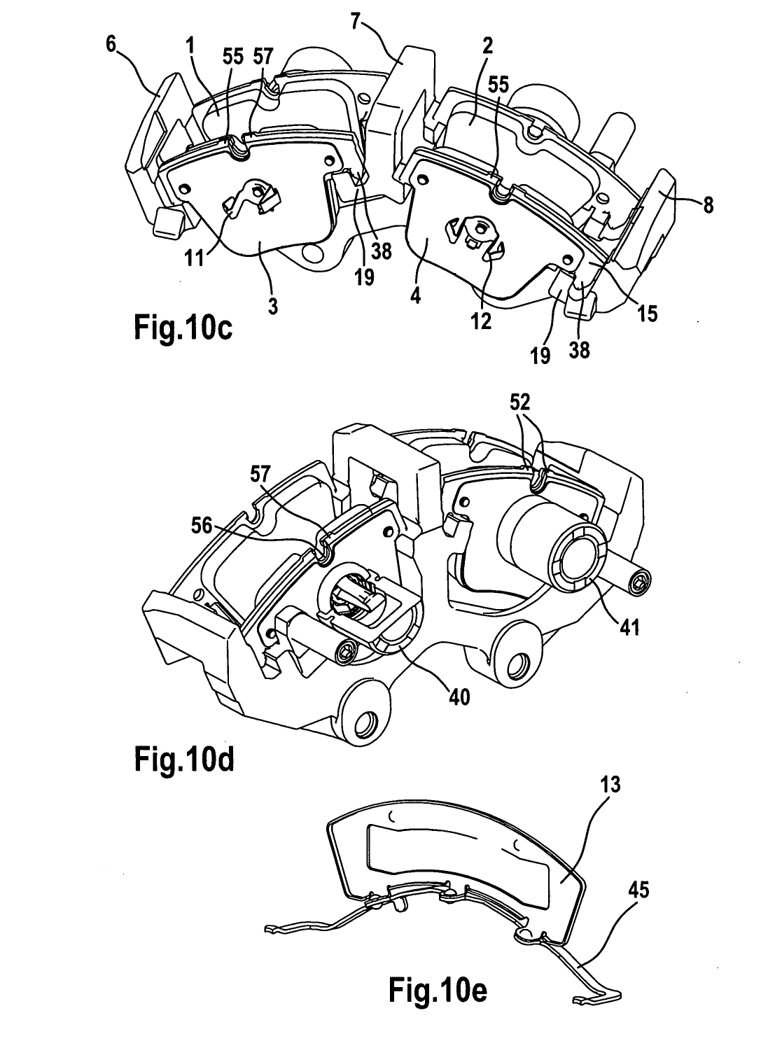

The brake pads 1-4 are retained in a rattleproof manner by way of springs 11, 12 in associated brake pistons or recesses on the fist side of the frame-shaped floating caliper. The front surface of the floating caliper that is positioned radially outside related to the vehicle can be furnished with a large-surface cover plate 13 in the mounted condition in order to reach optically favorable effects. As shown in FIG. 10e, it is especially possible to configure the cover plate 13 in conjunction with a multi-piece sheet-metal housing spring 45 that is used to clamp the floating caliper 31 relative to the brake support member 5. In this arrangement, the spring secured to the floating caliper 31 makes catch with its free ends below the arms 6 and 8.

The angled arrangement of the brake pads, on the entry and exit side, makes it principally impossible without further measures to mount the pre-assembled floating caliper with brake pads by way of a radial insertion to the brake support member because undercuts would occur in the mounting direction 14. However, the brake pads 1-4 can be displaced laterally by a distance S due to their respective attachment in the brake piston or in the floating caliper by way of springs 11, 12. This lateral displacement is enforced according to FIGS. 5 and 6 by mounting slopes or guiding slopes 17 at lateral shoulders 15 of the brake pads (in particular at hooks 38), which in the event of radial insertion of the floating caliper with brake pads in the direction of the arrow 14 will meet the broached profile 19 in the support member 5. By way of the inclined guiding slopes or sliding surfaces 17 at the lateral shoulders of brake pads 1-4, the latter are guided outwards in a circumferential direction by a defined rate 18 during the radial installation of the floating caliper until the respective brake lining with its lateral shoulder can catch the inclined broached profile 19. This order of assembly of the disc brake of the invention will be illustrated making reference to the example of the brake pads and the brake support member in FIGS. 5-6.

Said lateral movability of the brake pads in circumferential direction is further achieved according to FIG. 2 because the radially outwards pointing hooks 44 of the brake pads abut in each case only on the tangential outside surface 20, 21 of the floating caliper 31. At the inwards disposed lateral hooks that point in a radially upward direction, a clearance ‘S’ must prevail which is sized exactly as required by the brake pad to overcome the undercuts for a lateral yielding during the assembly of the pre-assembled floating caliper and brake support member.

The mounting springs 11, 12 of the brake pads 1 to 4 will correspondingly yield tangentially during the floating-caliper assembly and will center the brake pads in axial and radial directions after the assembly. A low-cost assembly concept with a radial mounting direction 14 (FIG. 5) for the pre-assembled floating caliper with brake pads on the brake support member is achieved due to the special arrangement of the brake pads permitting a lateral yielding during the assembly of the pre-assembled floating caliper on the brake support member.

A favorable improvement of the floating caliper 31 of the invention is achieved in that the floating caliper additionally has a frame-shaped design and includes at least two brake pads 1 to 4 on each brake disc side. This fact enhances both the brake performance that can be achieved and the braking comfort of the entire disc brake. The friction surfaces of the individual brake pads are almost square in their geometrical shape and have dimensions that are favorable for the braking function. This permits above all subdividing the tangentially long brake pads known from multi-piston disc brakes per disc friction surface into two small brake pads. This brake pad geometry has positive effects in terms of comfort, wear and the interaction of the friction partners, meaning brake pad and brake disc. Passing the still rotating brake disc through the brake pads that are compressed during the braking operation is optimized because the brake pads, due to their reduced tangential size, can better adapt to temporary variations in geometry at the brake disc caused by temperature and pressure. Besides, positive effects are achieved with respect to the tendency of the entire disc brake to develop uneven thickness at the brake disc.

With all these positive effects achieved, the basic design of the brake pads and the brake support member as a brake concept is maintained, with brake pads that are preferably supported in a pulled manner in the brake support member. In addition, still larger brake pad surfaces (>100 cm²) per friction surface of the brake disc can be realized without having to accept negative effects.

The maximum circumferential force to be transmitted per brake pad is reduced by splitting the circumferential brake force to several, in particular four, brake pads. This allows designing the brake pads to comply with a purely pulled load, what ensues major improvements in terms of comfort. The individual brake pads are optimized with respect to the geometric dimensions of their friction surfaces, and the width of the friction surfaces corresponds substantially to the height of the friction surfaces. In addition, the brake pads are arranged concentrically within the brake support member.

Improved variants of the disc brake arrange for the use of floating-caliper constructions with a still larger number of brake pads. For example, a floating caliper of this type can accommodate three brake pads on each brake disc side, and the brake pads are displaceable on the brake support member and supported in a circumferential direction as described hereinabove. To this end, the brake support member includes four support member arms projecting over the brake disc. In particular, the brake pads are displaceably supported on the brake support member or the support member arms also in this arrangement by realizing the push/pull principle.

Further expedient detailed features of the invention can be seen in the embodiments in FIGS. 1 to 6.

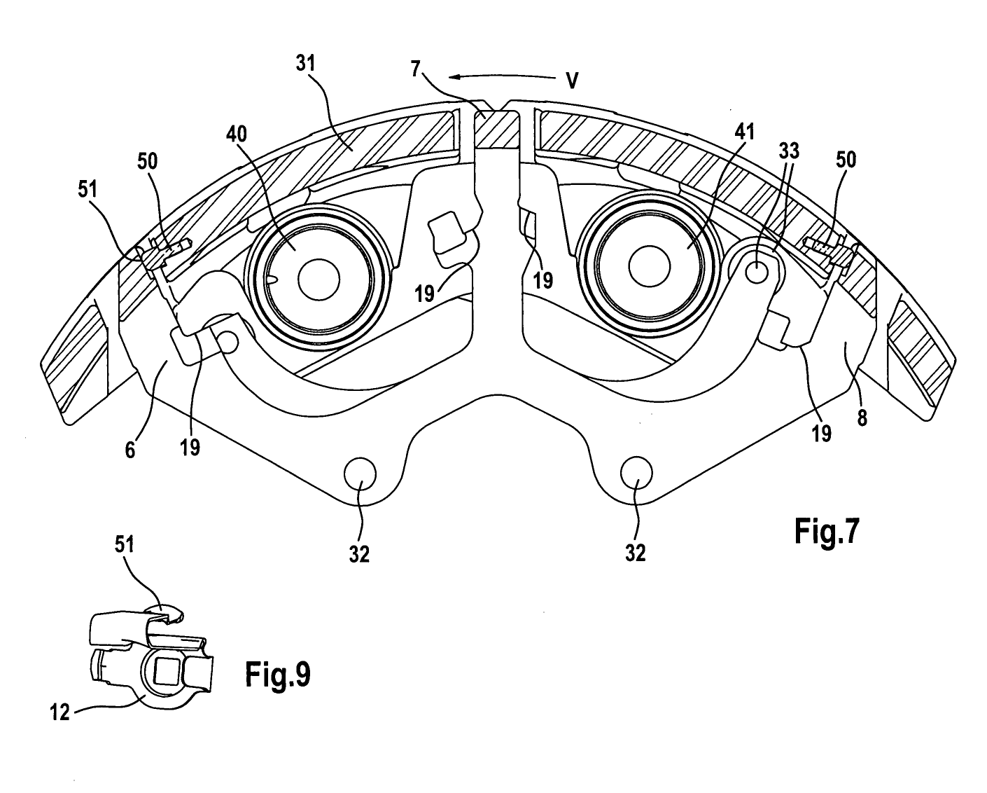

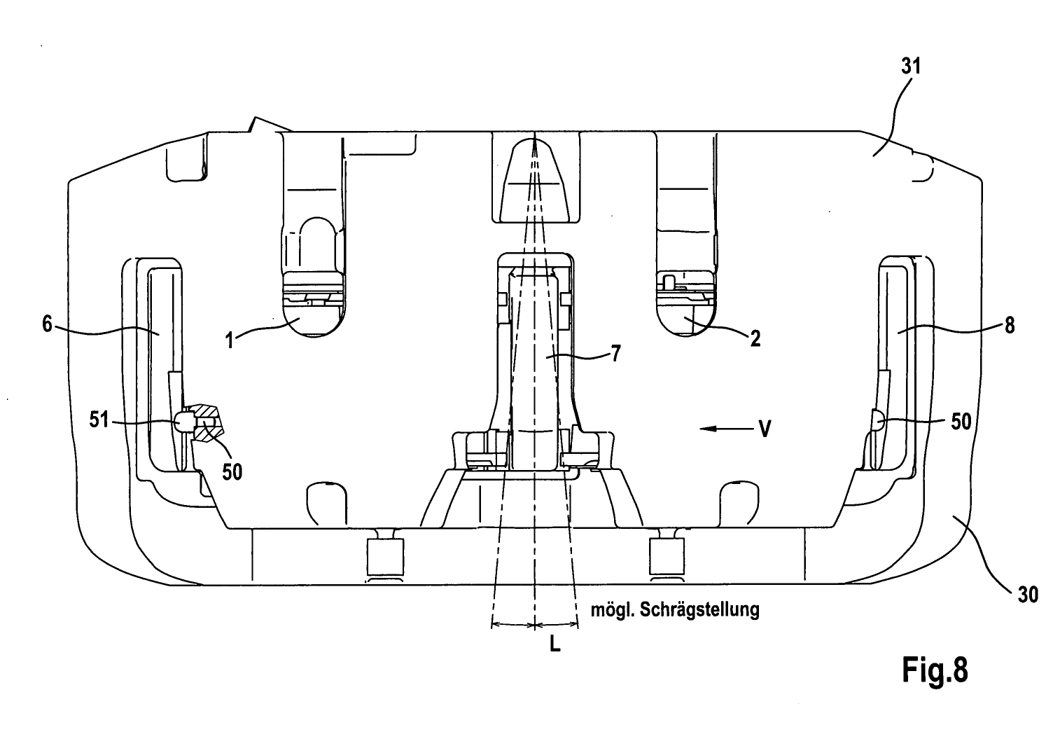

As can be seen from FIGS. 7 and 8, one or two self-locking screws 50 are screwed into the caliper to limit the inclined position of the caliper 31. The screw head 51 has a crowned design and, when subjected to load in a circumferential direction (example: in the forward direction V), gets into contact with the unloaded support member arm 6 on the exit side. The tangential inclined position of the caliper, which will be referred to as housing in many cases in the following, can be adjusted by way of the screw-in depth of the screws 50. Decisive for this condition is the exit-side screw on the left in FIG. 7, because the housing will always abut on the exit-side support member arm during forward travel. Said exit-side support member arm does not need to transmit any force of the pads in a circumferential direction during the forward direction of rotation with the caliper at issue. Arms 7 and 8 exclusively transmit said force by during forward travel. Arm 6 can be used exclusively to accommodate the tangential supporting forces of the housing. This permits very accurately predetermining and durably fixing the tangential inclined position of the housing.

After the exit-side screw has been adjusted, it is possible to also position the entry-side screw 50 on the right in FIG. 7, if it exists. The objective is to achieve a small tangential clearance (short caliper movement forward/backward). Optimal in this respect could be a clearance of 0.1 to 0.4 mm.

The adjustment of the inclined position is advantageously executed on or in a measuring and adjusting device. The assembly of a housing with bushings on a support member with guiding pins can be inserted into a device, measured and fixed in the desired inclined position by way of the setscrew. To this end, preferably large (thick) fist-side pad specimens must be mounted in order to simulate the optimal housing position on the support member in connection with a brake disc specimen. This operation is largely automated for reasons of clock times and quality.

Alternatively, the screws may also be adjusted on a gauge without a special pairing with the support member, what is disadvantageous because it increases the tolerances.

The technical advantages over prior art solutions consists in a major reduction of tolerances with respect to the inclined position. The novel possibility of adjusting the housing's inclined position is achieved in connection with the brake support member at issue and the unloaded exit-side support member arm 6. This leads to major advantages in terms of pad wear and comfort.

To still further enhance comfort, the outward fist-side pad holding springs 12, as shown in FIG. 9 and different from FIG. 1c, are provided with a third spring arm 53, which may also be envisaged with respect to the piston-side springs 11. As a result, the pad is urged against the broached profile 19 to avoid vibrations. This applies in particular when the housing holding spring 45 in FIGS. 1a and 2 is possibly unable to fulfill this task completely.

FIGS. 10a to 10d show a second embodiment of the invention largely corresponding with the embodiments according to FIGS. 1a to 1d. Therefore, only the differences between the second embodiment and the first embodiment will be dealt with in the following. Like reference numerals have been assigned to identical components in the two embodiments. In FIG. 10a the housing holding spring 45 is shown in a broken fashion so that the cover plate 13 is shown only in part. This provides an open view at two holes 42, 43 provided in the outward leg of the fist-type caliper 31, with the springs 11, 12 of the two outside brake pads 3, 4 being locked in the edges of said holes. The holes 42, 43 additionally permit machining the cylinders (not shown) of the caliper 31 in which the pistons 40, 41 (see FIG. 10d) are guided. In case of need, the holes can have a circular design or any other appropriate shape allowing the insertion of a tool for machining the mentioned cylinder.

In FIG. 10e, the housing holding spring 45 is illustrated separately which makes catch at the outward leg of the caliper 31 and, with its outside ends, is supported from below on the arms 6 and 8 of the brake support member 5, with the result that the outside part of the caliper is pulled in a radially downward direction against the brake pads 3, 4.

Further major variations of the second embodiment compared to the embodiments according to FIG. 1 can be taken from FIG. 10c. As a comparison between FIG. 10c and FIG. 1c shows, the backing plates of the brake pads 1 to 4 are provided with hooks 38 only on the right entry side, that is on the right hand in FIG. 10c. Accordingly, the broached profiles 19 are configured as grooves only there, the inside groove wall undercutting the hooks 38 and thereby rendering it possible to transmit the force that acts on the brake pads as a tensile force onto the arms 7 and 8. The ends of the brake pads 1 to 4 which are in each case disposed on the trailing-end side that is on the left in FIG. 10c do not have hooks but only shoulders that can accommodate compressive forces. It is hereby achieved that the brake pads can only be subjected to tensile forces in the forward direction of rotation and only to compressive forces in the backward direction of rotation. It is, however, possible to subject the brake pads in a forward direction of rotation both to tensile forces and to compressive forces (push-pull principle).

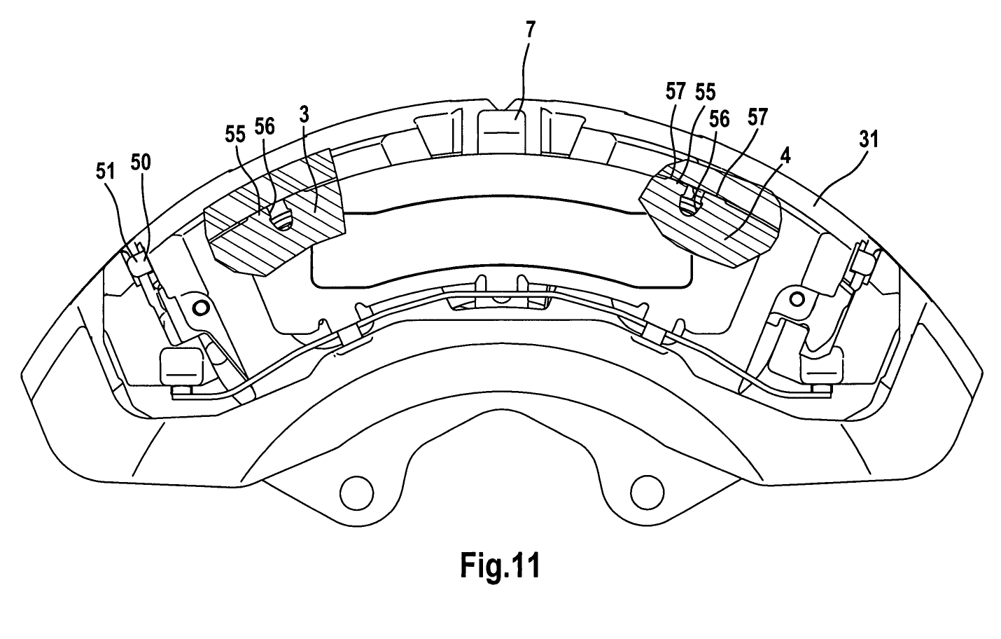

Another major difference of the second embodiment according to FIG. 10c over the first embodiment according to FIG. 1c resides in the support of the caliper 31 on the brake pads 3 and 4. While, as is described in connection with the embodiment according to FIG. 2, the caliper 31 is supported on the lateral shoulders 15 of the brake pads in the first embodiment, the caliper is now supported on separate projections 55 of the brake pads, as will be explained in detail in connection with FIG. 11.

FIG. 11 largely corresponds to FIG. 2 so that only the differences over this Figure are explained at this point. In FIG. 11, the caliper looked at from the outside is illustrated in a way as if broken out at two locations. The broken-out locations show a section of the brake pads 3, 4 with projections 55 on which the caliper abuts, likewise in a cross-sectional view. The projections and brake pads are also clearly visible in FIG. 10c. Further, recesses 56 that are open to the outside are inserted at the level of the projections, and sensors can be mounted into said recesses. This way each projection 55 includes two abutment surfaces 57, on which the caliper 31 is supported.

FIG. 11 further displays adjusting means 50 for adjusting the possible inclined position of the caliper, as described already in connection with FIGS. 7 and 8. While the adjustable shoulder 51 in these Figures was formed of the head of a setscrew 50 that can be screwed into the caliper 31, the adjustable shoulder 51 in FIG. 11 is formed of the head 51 of a pluggable pin, the length of which projecting from the caliper is characterized by a corresponding number of annular grooves at the head of the pin. The caliper is aligned in relation to the support member 5 because the position of the caliper is measured and a pin with a suitable head length is subsequently inserted into the caliper. As becomes apparent from FIG. 8, the adjusting means 50 are preferably inserted on the side of the caliper remote from the piston because the displacements in an inclined position are most significant herein.

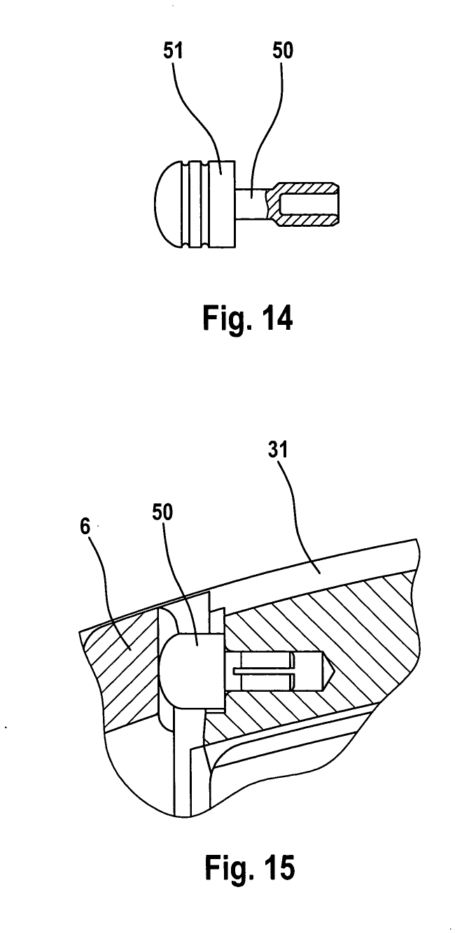

Instead of the self-locking screws explained hereinabove, it is also, possible to use pins in different lengths as adjusting means 50, as can be seen in FIG. 14 for example. The adjustment can be made similarly to the adjustment made for the screws. After having measured the brake in a device, the fitting pin is automatically inserted. The pins have a crowned surface and circumferential grooves, which characterize the length of the head of the pin. Said pins are inserted into the caliper to end flush on both sides, as has been described already hereinabove. FIG. 15 shows in a cross-sectional and broken view a pin 51 inserted into the caliper 31 and supported on the arm 6.

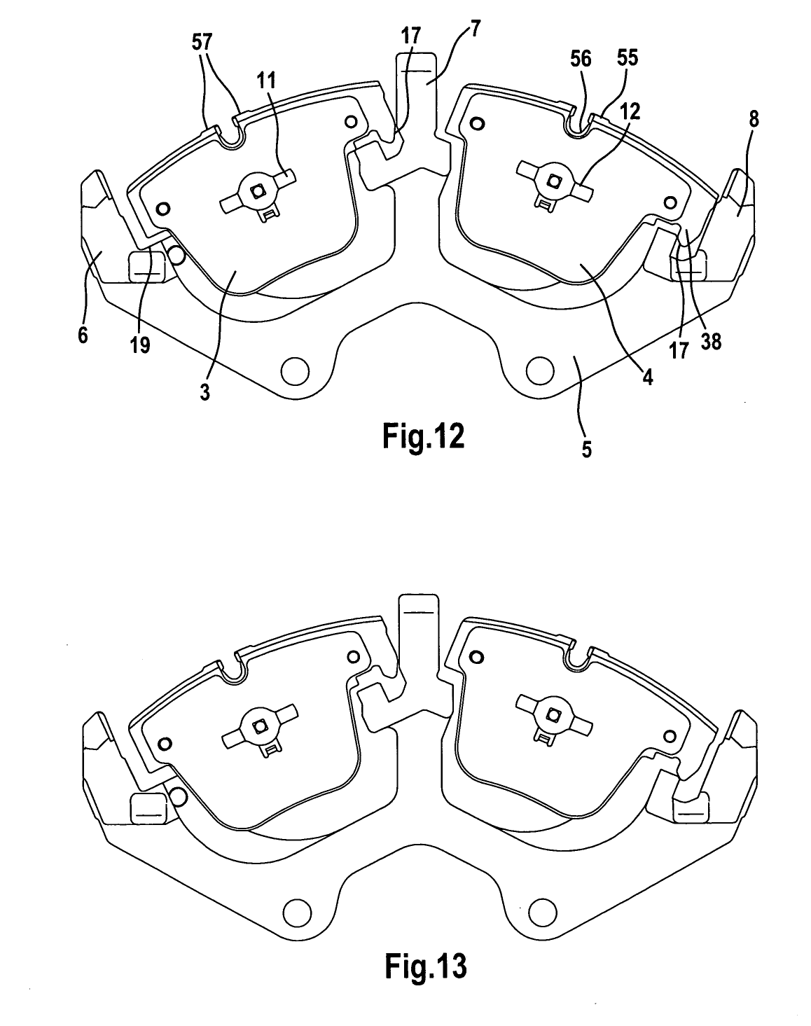

FIGS. 12 and 13 of the second embodiment correspond to FIGS. 5 and 6 of the first embodiment. The difference mainly involves that the brake pads have an unsymmetrical design and have no hooks 38 on the exit side, and the associated broached profiles 19 accordingly are not configured as grooves. FIGS. 12 and 13 represent the movement of the brake pads 3, 4 during mounting the caliper (not shown) on the brake support member 5. It can be seen in this arrangement how in FIG. 13 the brake pads 3, 4 and their hooks 38 are placed still above the broached profile 19 or groove 19, respectively, and then during radial lowering of the caliper according to FIG. 12 simultaneously execute a movement in circumferential direction, by way of which they are inserted with their hooks 38 into the associated groove. When dismounting the brake pads elastically suspended in the caliper 31, the movement of the brake pads is correspondingly reversed so that the brake pads change from the position in FIG. 12 into the position of FIG. 13.

1-23. (canceled)

24. Floating-caliper brake including a brake support member, a floating caliper straddling the outside edge of a brake disc and being axially displaceably guided on the brake support member, brake pads arranged on either side of the brake disc and enclosed by floating caliper, with at least two of the brake pads being arranged on the axially inside surface of the brake disc and at least two of the brake pads being arranged on the axially outside surface, the inboard brake pads being displaceably guided on the brake support member,
wherein the two outside brake pads are supported by arms of the brake support member that straddle the brake disc, and in that the floating caliper makes catch at the two outside brake pads simultaneously.

25. Floating-caliper brake as claimed in claim 24,
wherein the brake support member comprises at least three, especially exactly three arms straddling the brake disc, extending in an axial direction and directly accommodating the forces exerted by the brake pads.

26. Floating-caliper brake as claimed in claim 25,
wherein at least the leading-edge arm and the middle arm of the three arms are provided with grooves engaging into which are essentially radially extending, preferably radially inwards pointing lateral hooks of the brake pads.

27. Floating-caliper brake as claimed in claim 24,
wherein the arms and the brake pads are so configured that in the forward direction of rotation of the brake disc the brake pads are only subjected to tensile load in circumferential direction and only to compressive stress in the backward direction of rotation.

28. Floating-caliper brake as claimed in claim 25,
wherein exclusively the leading-edge arm and the middle arm of the three arms are provided with each one groove, into which at least the two outward brake pads are engaged with an associated lateral hook in such a fashion that the brake pads are subjected to tensile load when the brake disc is rotated in the forward direction of rotation, and that preferably the sides of the brake pads lying opposite in circumferential direction have a design without hooks.

29. Floating-caliper brake as claimed in claim 24,
wherein brake pads arranged in one plane are positioned at an angle relative to each other, and the abutment surfaces of the brake pads and of the arms corresponding to each other are likewise arranged at an angle in order to transmit forces.

30. Floating-caliper brake as claimed in claim 24,
wherein both the brake pads on the piston side and the brake pads on the opposite outside surface of the floating caliper are secured in the floating caliper so as to be displaceable at least laterally.

31. Floating-caliper brake as claimed in claim 29,
wherein guiding slopes are provided at the brake pads, in particular at their hooks, in such a manner that when the caliper is mounted onto the brake support member, the brake pads are moved not only radially with the caliper but also tangentially with respect to it in a direction pointing away from the mid-perpendicular of the caliper and, in doing so, the hooks are being mounted in the associated grooves.

32. Floating-caliper brake as claimed in claim 29,
wherein guiding slopes are provided at the brake support member, in particular at its arms, in such a manner that when the caliper is mounted onto the brake support member, the brake pads are moved not only radially with the caliper but also tangentially with respect to it in a direction pointing away from the mid-perpendicular of the caliper and, in doing so, the hooks are being mounted in the associated grooves.

33. Floating-caliper brake as claimed in claim 26,
wherein the middle one of the three arms includes two grooves extending in parallel in axial direction relative to each other, said grooves being engaged by lateral hooks of the adjoining brake pads.

34. Floating-caliper brake as claimed in claim 24,
wherein all the brake pads in the brake have the same symmetric dimensions.

35. Floating-caliper brake as claimed in claim 24,
wherein the brake pads include additional radially outwards pointing hooks that make catch at associated edges of the floating caliper and, in doing so, transmit tensile forces exerted on the brake pads onto the floating caliper.

36. Floating-caliper brake as claimed in claim 26,
wherein the distance and the width of the grooves in relation to the distance of the hooks engaging the grooves is dimensioned such that only pulling forces are exerted on the brake pads through the hooks.

37. Floating-caliper brake as claimed in claim 25,
wherein the floating caliper in its mid-area has an opening into which the middle arm extends.

38. Floating-caliper brake as claimed in claim 24,
wherein at least the outward brake pads include projections that point radially to the caliper and on which the caliper is guided in an axial direction.

39. Floating-caliper brake as claimed in claim 24,
wherein the floating caliper is provided with two cylinders, in that the floating caliper at its outside leg remote from the cylinders includes preferably circular holes, and the brake pads are elastically suspended on the walls of the pistons guided in the cylinder, or the holes, by way of springs secured to their carrier plates.

40. Floating-caliper brake as claimed in claim 24,
wherein the floating caliper is a fist-type caliper, and in that the fist-type caliper includes a frame-shaped web embracing the two outside arms.

41. Floating-caliper brake as claimed in claim 24,
wherein adjusting means are provided allowing the adjustment of the position of the caliper with respect to the position of at least one of the support member arms.

42. Floating-caliper brake as claimed in claim 41,
wherein the adjusting means are arranged in the area of the free end of at least one of the arms, in particular the exit-side arm.

43. Floating-caliper brake as claimed in claim 41,
wherein the floating caliper is a fist-type caliper, in that the outside arms extend until the level of the axial lateral surfaces at the bridge of the fist-type caliper, and in that at least one axial lateral surface includes adjusting means by means of which the position of the caliper can be fixed in relation to the arm in a circumferential direction.

44. Floating-caliper brake as claimed in claim 42,
wherein the adjusting means are secured to the caliper and configured as a shoulder adjustable in tangential direction and pointing in the direction of an abutment surface on the associated support member arm.

45. Floating-caliper brake as claimed in claim 44,
wherein the adjusting means consist of a setscrew that can be screwed into the bridge of the caliper or a pin of variable length that can be plugged into an aperture in the bridge.

46. Floating-caliper brake as claimed in claim 45,
wherein the two axial bridge surfaces opposite each other include adjusting means, in that the adjusting means are pluggable pins provided with a stop, and the pin end forming the shoulder and projecting from the caliper bridge is provided with markings, preferably circumferential grooves, and the number of the grooves depends on the height of the shoulder.

47. Floating-caliper brake as claimed in claim 38,
wherein in the area of the projection, a recess is provided in the brake pad to accommodate a sensor.
